(19) United States
(12) Patent Application Publication
(10) Pub. No.: US 2006/0084035 A1
(43) Pub. Date: Apr. 20, 2006

(54) Dental implant

(75) Inventor: Ulrich Volz, Meersburg (DE)

Correspondence Address: BURR & BROWN, PO BOX 7068, SYRACUSE, NY, 13261-7068, US

(73) Assignee: Volzirkon GmbH & Co. KG, Meersburg (DE)

(21) Appl. No.: 11/255,782

(22) Filed: Oct. 21, 2005

Related U.S. Application Data
(63) Continuation of application No. PCT/DE04/00868, filed on Apr. 26, 2004.

(30) Foreign Application Priority Data
Apr. 25, 2003 (DE) 103 19 036.8

(51) Int. Cl. A61C 8/00

(52) U.S. Cl. 433/173; 433/201.1

(57) ABSTRACT

A dental implant including a one-piece base body having a threaded section and a pin on which a dental crown can be mounted. The one-piece base body is made from zirconium oxide or a mixture of zirconium oxide and aluminum oxide.

### CROSS REFERENCE TO RELATED APPLICATIONS

This application is a continuation of International Application No. PCT/DE2004/000868, having an international filing date of Apr. 26, 2004, which designated the United States, and claims the benefit under 35 USC §119(a)-(d) of German Application No. 103 19 036.8, filed Apr. 25, 2003, the entireties of which are incorporated herein by reference.

### FIELD OF THE INVENTION

The invention relates to a dental implant including a one-piece body having a threaded section and a pin on which a dental crown can be mounted. The one-piece base body is made from zirconium oxide or a mixture of zirconium oxide and aluminium oxide.

### BACKGROUND OF THE INVENTION

Dental implants are used as tooth root replacements after loss of teeth, for example for receiving solidly cemented dental crowns and bridges and also superstructures for anchoring of removable dental prostheses.

A dental implant made of glass ceramic and used for replacement of tooth roots is known from the German utility model G 93 06 758.5. The disclosed dental implant has a base body with four parts. Two parts are provided for anchoring in the bone, one of these parts having a thread. A third subsequent part constitutes a transition area within the oral mucosa. The fourth part is arranged outside of the jaw in the implanted state and is used for mounting a dental crown or dental structures for tooth replacement.

Glass ceramic has the advantage that, compared to titanium implants, it becomes better incorporated after implantation. Moreover, glass ceramic can be made in tooth colors, so that the dental implants do not show through as dark features beneath crowns and the gum. Because of the one-piece design, the part protruding above the gum is comparatively more rotationally stable for attachment of a dental crown after the dental implant has become incorporated. Moreover, glass ceramic can be worked on subsequently, for example ground, in the implanted and incorporated state. This means that individual stump shapes can be realized.

However, a disadvantage of glass ceramic is the sometimes inadequate stability against fracturing.

### SUMMARY OF THE INVENTION

The object of the invention is to make available a dental implant which, in addition to the stated advantages of glass ceramic, has improved stability in particular.

One embodiment of the present invention is a dental implant having a one-piece base body which comprises a threaded section for screwing into the jawbone so that it becomes incorporated therein, and a pin which protrudes from the gum after the implant has become incorporated in the jaw and on which a secondary structure can be mounted, in particular a dental crown, prosthesis or connecting bar. An important aspect of the invention lies in the fact that the one-piece base body is made at least largely, possibly completely, from zirconium oxide or a mixture of zirconium oxide and aluminum oxide. In addition to the advantages of being able to be produced in a tooth color and being able to be ground, zirconium oxide or a mixture of zirconium oxide and aluminum oxide has a comparatively high degree of strength. It has also been found that a dental implant made from these materials has an incorporation behavior the quality of which is at least comparable to that of glass ceramic or titanium. In a mixture of zirconium oxide (e.g. ZrO₂) and aluminum oxide (e.g. Al₂O₃), the zirconium oxide proportion is preferably about 75% by weight and the aluminum oxide proportion is about 25% by weight, for example. In the mixture, and also in the implant predominantly comprising zirconium oxide, it is additionally advantageous if a proportion of about 5% by weight of another oxide, for example yttrium oxide (Y₂O₃) is added. If added in the mixture, the Y₂O₃ would replace 5% by weight of the aluminum oxide.

In a particularly preferred embodiment of the invention, an intermediate section which extends outward over the thread diameter in a collar shape is arranged between the threaded section and pin. The collar shape means that the dental implant can settle in the gum and if appropriate in the jawbone across a comparatively greater surface area than a conventional implant, such that the diameter of the implant in the area where it passes through the gum is substantially increased. This permits an esthetic and anatomically correct configuration of a secondary crown, since the latter's diameter is far in excess of that of the threaded section. In addition, a kind of compression takes place in the collar area during insertion, this compression leading to complete sealing and ensuring that epithelium does not grow in and cause a defective connection between the implant and bone. The widening effect provided by the collar also reduces the risk of fracturing of the implant.

For an appreciable supporting action, the diameter of the collar should be at least 10%, more preferably 40%, greater than the diameter of the base body in the threaded area. For example, the diameter of the collar is approximately 50% greater than the thread diameter.

In a particularly preferred embodiment of the invention, the pin has a conical part, in particular over a considerable extent, for example greater than 50% of its length. This has the advantage that a crown can more easily be anchored in a stable manner onto a stump by a clamping effect when the crown is pushed onto the cone. This is especially the case when the pin tapers conically starting from the intermediate section and, for example, only at an end area does the pin have a structure permitting engagement of an insertion screwing instrument. Advantageously, only a small portion of the end area of the pin is designed as a hexagon. However, a great many other structures are possible at the end of the pin, for example negative slit or cross structures.

A conical or tapering portion of the pin has a further important advantage. Generally, the shapes for crowns and bridges are obtained by taking an impression of a prepared tooth stump or of an implant from the patient. The impression that has been taken is used to create a plaster model from which a matching dental crown or bridge is produced. In a more recent method, an impression is likewise taken from the patient. However, this is then followed by laser scanning in order to determine the correct fit. A dental crown or bridge is then milled directly using the data obtained from this laser scanning. This procedure is referred to in dentistry as a CAD/CAM procedure. CAD stands for computer-aided design, and CAM for computer-aided manufacturing. In this procedure, it has to be borne in mind that not all shapes of bridges and crowns can be produced using current milling machines. In the case of a pin which is at least substantially conical, the corresponding cavity in a crown or bridge is likewise conical. In the CAD/CAM procedure, such a shape can be safely produced in particular for an inclination angle of the flanks of 4° and greater.

Moreover, it is particularly advantageous if a transition into the pin, in particular starting from the intermediate section, is realized in the form of a rounded corner. By avoiding sharply edged transitions it is possible, on the one hand, to avoid a notch effect during loading, with the possible consequence of a material fracture, and, on the other hand, machine production of suitable crowns and bridges by current CAD/CAM procedures is made possible. The rounded corner preferably has a radius of not less than 0.4 mm in particular. In front of the rounded corner and the pin, there is a shoulder, for example a circular shoulder perpendicular to the longitudinal axis or substantially perpendicular thereto. The shoulder preferably has a width of about 0.4 mm or more. Furthermore, when using a plurality of implants, a shoulder of this type means that abutment divergences can be compensated for the most part without grinding work on the pin.

In addition, the stability of the secondary crown is greatly increased by the thick crown edge thus made possible. Such a shoulder can be obtained with the required precision using a scanner in a CAD/CAM procedure. After the rounded corner, it is advantageous if the pin tapers thereon without overhang. For a defined and comparatively simple implantation of the dental implant, it is further proposed that the threaded section extends as far as the end of the base body lying remote from the pin. In this connection, it is additionally preferred if the threaded section tapers at the end of the base body, for example in a conical taper. The implant can in this way be better inserted into the drilled hole.

To further facilitate the insertion of the implant, it is additionally proposed that, at the end of the base body, a thread of the threaded section is interrupted by longitudinally extending recesses. The recesses preferably deepen from a starting point to the end of the base body on the face of the threaded section in such a way that, viewed in cross section, a kind of cross structure is obtained at the end of the threaded section. During implantation, bone can be received in the recesses, so that the bone does not impede the cutting work of the rest of the thread. Compared to a conventional threaded cutter, the longitudinally extending recesses thus act as a kind of groove in which chips collect. Moreover, in the phase of incorporation of the implant, the bone gathered in this area mechanically secures the implant against loosening.

### BRIEF DESCRIPTION OF THE DRAWINGS

An illustrative embodiment of the invention is shown in the drawings and is explained in greater detail with reference to further advantages and features of the invention.

FIG. 1 shows a side view of a dental implant in accordance with one embodiment of the present invention.

FIG. 2 shows a view of the bottom of the dental implant according to FIG. 1.

FIG. 3 shows a cross section through the dental implant according to FIG. 1 along the section line dₐ in FIG. 1.

FIG. 4 shows a detailed view of a thread on a threaded section of the dental implant according to FIG. 1.

### DETAILED DESCRIPTION OF THE INVENTION

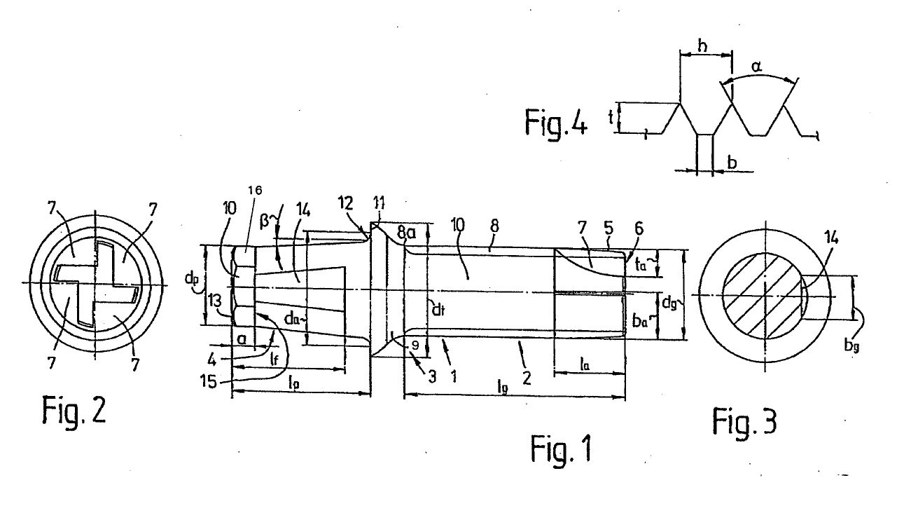

In FIGS. 1 to 4, a dental implant 1 is shown which comprises a threaded section 2, an intermediate section 3 and a pin 4. The threaded section 2, the intermediate section 3 and the pin 4 are positioned concentrically with respect to one another and are substantially rotationally symmetrical. The threaded section has a length l_{g} which is 10 mm here, by way of example. The threaded section tapers in the front area 5 so as to facilitate the insertion operation during implantation.

FIG. 4 shows an enlarged representation of the geometry of a preferred thread 8 in the non-tapering area. This thread is a right-hand cutting thread profile with, for example, a thread height h of 0.6 mm. The thread depth t is 0.34 mm, and the flank angle α is 60°. The thread 8 is configured as a trapezoid thread, with a thread width b of 0.18 mm at its foot.

In the front area 5, reaching as far as the end 6 of the threaded section 2, deepening recesses 7 (see also FIG. 2) are provided in the threaded section 2. The recesses 7 have a segment shape when seen in cross section. Along a length lₐ of 3.3 mm, for example, the recesses begin at the external diameter of the thread 8 and, seen in longitudinal section (see FIG. 1), with a radius r of in this case 5 mm run into the material of the threaded section 2 as far as the end 6 of the threaded section 2. The radius r leads to a recess having a depth tₐ of 1.2 mm, for example, at the end 6 of the threaded section 2.

The recess does not extend across the complete diameter d_{g} of the threaded section (d_{g} being 4 mm for example) but instead has a width bₐ, seen in the side view, of slightly greater than the radius of the threaded section 2, for example 2.1 mm.

The threaded section 2 merges into the pin 4 via the intermediate section 3 which has a collar-shaped widening 9. The collar-shaped widening 9 commences here at the thread start 8a, for example, and extends out in a gentle S-shaped curve to a diameter dₜ of, in the illustrative embodiment, 6 mm. The collar-shaped widening 9 then extends back via a circular shoulder 11 running perpendicular to the longitudinal axis 10 of the implant 1 and then, starting from a diameter dₐ of 5.12 mm for example, merges into a rounded corner 12 of the pin 4. The pin 4 has a length lₚ (here for example 6.3 mm) and tapers conically from the rounded corner 12 until, at a distance a (for example 1 mm) in front of its end 13, it has reached a diameter dₚ of 3.4 mm, for example. The cone angle β of the pin 4 is 5° for example.

For better handling of the implant 1 and more reliable anchoring of a dental crown, especially with respect to twisting the dental crown, the pin 4 has a flattened surface 14 (see also FIG. 3). This extends over a large part of the cone, for example from the end 15 of the cone in the direction toward the collar-shaped widening 9, up to a length l_{f} of the pin 4. There, the flattened surface has a width b_{g} of 2 mm, for example.

A hexagon nut 16 is fitted on the end 15 of the cone-shaped portion of the pin 4 in the illustrative embodiment, so that the implant 1 can be inserted into a pre-drilled hole in the jawbone by means of a suitable insertion instrument (ratchet screw driver).

The insertion operation is made easier by the decreasing diameter of the thread 8 in the area 5 and also by the recesses 7, which form grooves for chips, so that shaved-off material can wedge itself tightly between the drilled hole and implant 1. At the front end 6, the implant 1 has a kind of cross shape (see FIG. 2) provided by the recesses 7, such that insertion into a pre-drilled hole in the jawbone is made easier by this means, as well. The thread 8 is completely formed only starting from a distance lₐ from the end of the implant 1.

### LIST OF REFERENCE NUMBERS

1 dental implant
2 threaded section
3 intermediate section
4 pin
5 front area
6 end
7 recess
8 thread
8a start of thread
9 collar-shaped widening
10 longitudinal axis
11 circular shoulder
12 rounded corner
13 end
14 flattened surface
15 end
16 hexagon nut

1. A dental implant comprising a one-piece base body having a threaded section for screwing into the jawbone of a patient, and a pin which is adapted to protrude from the gum of the patient after the implant has become incorporated in the jawbone and on which a dental crown can be mounted, wherein said base body comprises at least one of zirconium oxide and a mixture of zirconium oxide and aluminum oxide.

2. The dental implant claim 1, further comprising an outwardly extending intermediate section arranged between said threaded section and said pin.

3. The dental implant of claim 1, wherein a diameter of said intermediate section is at least 10% greater than the external diameter of said threaded section.

4. The dental implant of claim 1, wherein said pin has a conical portion.

5. The dental implant of claim 2, wherein a transition between said pin and said intermediate section is in the form of a rounded corner.

6. The dental implant of claim 2, wherein said pin has a conical portion starting from said intermediate section.

7. The dental implant of claim 1, wherein said pin ends with a structure which permits engagement of an insertion screwing instrument.

8. The dental implant claim 1, wherein said threaded section extends to an end of said base body that is remote from said pin.

9. The dental implant of claim 1, wherein said threaded section tapers at an end of said base body.

10. The dental implant of claim 1, wherein a thread of said threaded section is interrupted by longitudinally extending recesses in a region proximate an end of said base body.

11. The dental implant of claim 1, wherein a transition into said pin is in the form of a round corner.
